(19) United States
(12) Patent Application Publication
(10) Pub. No.: US 2016/0350247 A1
(43) Pub. Date: Dec. 1, 2016

(54) LATENCY IMPROVEMENTS ON A BUS USING MODIFIED TRANSFERS

(71) Applicant: INTEL CORPORATION, Santa Clara, CA (US)

(72) Inventors: John S. Howard, Portland, OR (US); Karthi R. Vadivelu, Folsom, CA (US); Abdul R. Ismail, Beaverton, OR (US)

(73) Assignee: INTEL CORPORATION, Santa Clara, CA (US)

(21) Appl. No.: 14/750,603

(22) Filed: Jun. 25, 2015

Related U.S. Application Data
(60) Provisional application No. 62/166,513, filed on May 26, 2015.

(51) Int. Cl. G06F 13/36; G06F 13/42; G06F 13/40

(52) U.S. Cl. CPC G06F 13/36; G06F 13/4063; G06F 13/4282

(57) ABSTRACT

Techniques for latency improvement are described herein. The techniques may include an apparatus having a receiver configured to receive transfers over a bus. The transfers include a periodic transfer at a predefined interval, wherein the periodic transfer is associated with a guaranteed bandwidth over the bus. The transfers may also include an asynchronous transfer at any time within the predefined interval. The apparatus may also include logic configured to implement a modified periodic transfer at an interval that is less than the predefined interval, and a modified asynchronous transfer comprising a priority status above the asynchronous transfer.

### CROSS-REFERENCE TO RELATED APPLICATION

The present application claims the benefit of U.S. Provisional Patent Application Ser. No. 62/166,513 by Howard et al., which is entitled ‘Latency Improvements On A Bus Using Modified Transfers’ and was filed May 26, 2015, the contents of which is incorporated herein by reference as though fully set forth herein.

### TECHNICAL FIELD

This disclosure relates generally to techniques for improving bus latency. Specifically, this disclosure relates to improving latency using modified transfers.

### BACKGROUND ART

Computing systems may include integrated circuits, systems on a chip (SOCs), and other circuit components as well as peripheral devices configured to communicate over a computer bus. In some cases, a given receiver may be communicatively coupled to a given endpoint over the computer bus, and may be associated with a standard of bus communications. In some cases, scheduling of transfers may be based on both periodic transfer types as well as asynchronous transfer types. In periodic transfer types, a given computer bus standard may provide guaranteed bandwidth over the computer bus to be initiated upon predefined intervals. In asynchronous transfer types, a transaction may be initiated over the computer bus on demand if bandwidth is available over the computer bus.

### BRIEF DESCRIPTION OF THE DRAWINGS

FIG. 1 illustrates a computing system having logic configured to implement modified transfer types.

FIG. 2 illustrates timing diagram of isochronous transfer over a computer bus.

FIG. 3 illustrates timing diagram of isochronous transfer over a computer bus as well as a modified asynchronous transfer.

FIG. 4 illustrates a block diagram of a method for improving latency over a computer bus according to techniques described herein.

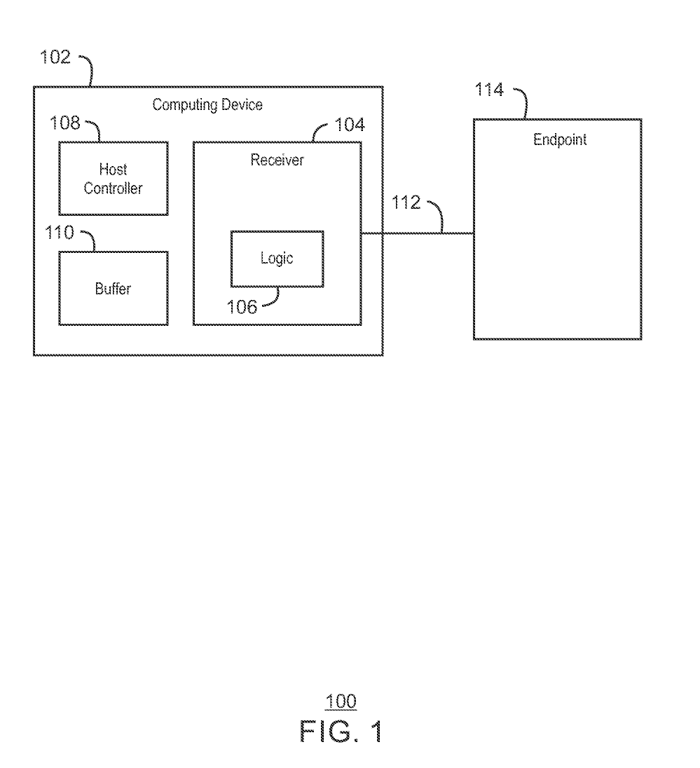

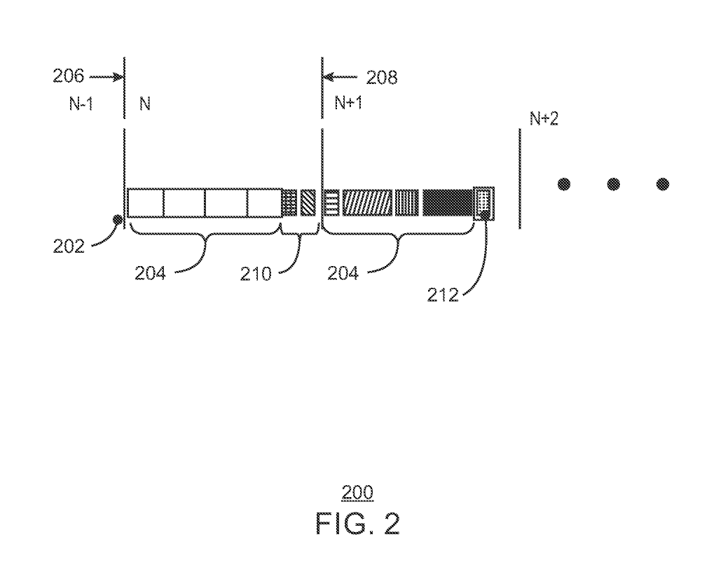

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The present disclosure relates generally to techniques for improving latency over a computer bus. As discussed above, in some cases a given receiver may be communicatively coupled to a given endpoint over the computer bus, and may be associated with a standard of bus communications. Scheduling of transfers may be based on both periodic transfer types as well as asynchronous transfer types. In periodic transfer types, a given computer bus standard may provide guaranteed bandwidth over the computer bus to be initiated upon predefined intervals. In asynchronous transfer types, a transaction may be initiated over the computer bus on demand if bandwidth is available over the computer bus.

An example of computer bus may include a bus having predefined service intervals for periodic transfer types and on demand and bandwidth available asynchronous transfer types. An example of a computer bus may include a Universal Serial Bus (USB) indicated in a specification standard entitled, The USB 3.1 Specification released on Jul. 26, 2013 and ECNs approved through Aug. 11, 2014,' referred to herein as the ‘USB specification.’ As discussed in more detail below, USB may include a time structure defining periodic transfer types that are configured to be scheduled at predefined periodic time intervals such as 125 microseconds. In some cases, a time structure may implicate service interval latencies. However, some applications such as audio applications, video applications, and the like, may require a lower latency than the service interval latency associated with the time structure. Further, USB guarantees bandwidth for periodic transfer types, while asynchronous transfer types are guaranteed delivery, but not necessarily bandwidth.

The techniques described herein include implementing modified transfer types. In a modified periodic transfer types, transfers may be scheduled at intervals that are a fraction of the predefined periodic interval. For example, in USB, the modified periodic transfer type discussed herein may include ten modified intervals of 12.5 microseconds for every predefined interval of 125 microseconds. Therefore, a microframe may be modified to a nanoframe, for example.

In regard to modified periodic transfer types, an improvement in latency may result as an upper bound on latency may be dictated by the fractional intervals introduced. In regard to asynchronous transfer types, the techniques discussed herein may include modified asynchronous transfer types wherein priority is given to the modified asynchronous transfer types above the asynchronous transfer types. In this scenario, modified asynchronous transfers may be placed ahead of any concurrent or pending asynchronous transfer types.

Further, although asynchronous transfer types may not be associated with a latency guarantee, modified asynchronous transfer types may be associated with a maximum latency guarantee between accessing the computer bus for a specific asynchronous endpoint data flow. In terms of latency of modified asynchronous transfer types, a latency guarantee may also be provided as a maximum latency measured from when a buffer associated with a modified asynchronous transfer is made available to a host controller until the host controller begins a transaction on the computer bus for that buffer. Further, although modified asynchronous transfer types may have a bandwidth-available priority, in some cases, a host controller may pause a periodic transfer type to enable transfer of a modified asynchronous transfer as long as a service interval deadline for the periodic transfer is preserved.

The techniques described herein provide variants on existing transfer types to allow a host controller scheduler associated with the computer bus to decouple scheduling transactions for lower latency flows in regard to minimum specifications provided for a given computer bus having predefined intervals. Although the techniques described herein are related to the USB specification discussed above, they may be implemented in any computer bus having predefined intervals.

An asynchronous transfer may be known as a bulk transfer. Accordingly, a transfer of a modified asynchronous transfer type may be referred to as a priority bulk transfer. However, for simplicity and consistency, a transfer of a modified asynchronous type may be generally referred to herein as a modified asynchronous transfer.

FIG. 1 illustrates a computing system having logic configured to implement modified transfer types. The computing system 100 may include a computing device 102 including a receiver 104 having logic 106, a host controller 108, and a buffer 110.

In some cases, components such as the logic 106 may be implemented as logic, at least partially comprising hardware logic. For example, the logic 106 may be electronic circuitry logic, firmware of a microcontroller, and the like. In some cases, the logic 106 may be implemented as instructions executable by a processing device, as a driver, and the like. In any case, the receiver 104 configured to receive transfers over a computer bus 112 from an endpoint 114. In some cases, the computer bus 112 may be a USB. The computer bus 112 may be associated with a time structure having periodic and asynchronous transfer types.

In some cases, the logic 106 may be configured to determine whether the endpoint 114 is capable of receiving and transmitting modifications to the periodic and asynchronous transfer types. A periodic transfer type is associated with a transfer at a predefined interval. The periodic transfer is associated with a guaranteed bandwidth over the bus. An asynchronous transfer type is a transfer performed at any time. If the endpoint 114 is indeed capable of accommodating modified transfer types, the logic may be configured to implement a modified periodic transfer at an interval that is less than the predefined interval, and a modified asynchronous transfer comprising a priority status above the asynchronous transfer.

For example, in the case where the computer bus 112 is an USB bus, the predefined interval is a microframe associated with a timing structure of the USB. In this scenario, the transfer interval for the modified periodic transfer may be a nanoframe. The modified periodic transfer may be associated with a guaranteed latency dictated by the interval of the modified periodic transfer.

The modified asynchronous transfer may be associated with a bandwidth limit at a priority below the guaranteed bandwidth of the periodic transfer. However, in some cases, the modified asynchronous transfer may be associated with a bandwidth limit at a priority equal to the guaranteed bandwidth of the isochronous transfer. In any case, the logic 106 may be configured to increase a priority of the modified asynchronous transfer above the periodic transfer, the modified periodic, or any combination thereof as long as a service interval deadline associated with the periodic transfer, the modified periodic, or any combination is preserved. In some cases, asynchronous transfer is associated with guaranteed delivery over the computer bus 112. In some cases, the logic 106 is configured to modify an interrupt moderation policy of the receiver 104. In this case, the interrupt moderation policy includes an interrupt interval for notification for completion of a transaction associated with any given transfer.

The logic 106 may be further configured to determine whether an endpoint of any given transfer is configured to handle the modified asynchronous transfer. In some cases, the logic 106 is further configured to determine whether an endpoint of any given transfer is configured to handle the modified periodic transfer.

FIG. 2 illustrates timing diagram of periodic transfer over a computer bus. At 202, a host computing device, such as the computing device 102 of FIG. 1, provides space in terms of time over the computer bus 112 for periodic transfers, asynchronous transfers, and modified periodic transfers. In some cases, the space in terms of time provided over the computer bus 112 for periodic transfers, asynchronous transfers, and modified periodic transfers may be provided by a host controller, such as the host controller 108 of FIG. 1.

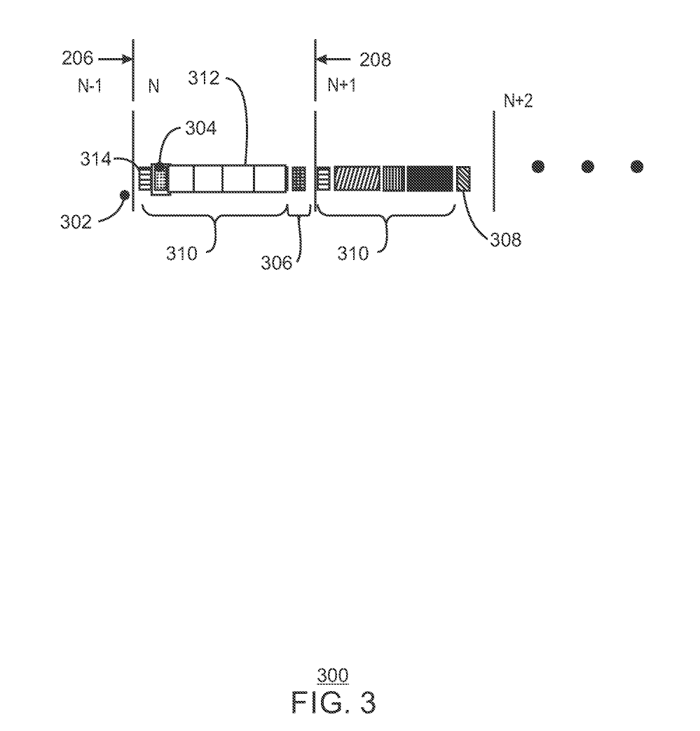

At blocks 204, modified periodic transactions may occur. The modified periodic transactions 204 may occur at a fraction of the interval defined between the boundary of the N−1 interval at 206 and the boundary of the N+1 interval at 208. In this scenario, asynchronous transfers 210 are initiated when bandwidth is available within the N interval. An additional periodic transfer indicated at 212 is placed in queue behind the asynchronous transfers 202. However, if the asynchronous transfer 212 were a modified asynchronous transfer as discussed above, it would be put ahead of the asynchronous transfers 202, as discussed in more detail below with regard to FIG. 3.

FIG. 3 illustrates timing diagram of periodic transfer over a computer bus as well as a modified asynchronous transfer. At 302, a host computing device, such as the computing device 102 of FIG. 1, provides space for periodic transfers, asynchronous transfers, modified periodic transfers, as well as modified asynchronous transfers. In some cases, the space for periodic transfers, asynchronous transfers, modified periodic transfers, as well as modified asynchronous transfers may be provided by a host controller, such as the host controller 108 of FIG. 1. A modified asynchronous transfer may be initiated at 304. In comparison to the asynchronous transfer 212 of FIG. 2, the modified asynchronous transfer 304 is prioritized ahead of other non-modified asynchronous transfers, such as asynchronous transfers 306 and 308. At blocks 310, modified periodic transactions may occur before and after the modified asynchronous transfer 304. For example, modified periodic transactions 312 may be occur after the modified asynchronous transfer 304, while the block 314 may be a non-modified periodic transfer. As discussed above, although modified asynchronous transfer types may have a bandwidth-available priority, in some cases, the host controller 108 may pause a periodic transfer type to enable transfer of a modified asynchronous transfer as long as a service interval deadline for the periodic transfer is preserved. Further, in some cases, a latency guarantee may also be provided as a maximum latency measured from when a buffer, such as the buffer 110 of FIG. 1, associated with a modified asynchronous transfer is made available to a host controller 108 until the host controller 108 begins a transaction on the computer bus 112 for that buffer 110.

As illustrated in FIG. 3, the non-modified periodic transfer 314, the modified asynchronous transfer 304, the modified periodic transfers 312, as well as the non-modified asynchronous transfer 306, may occur in the interval defined between the boundary of the N−1 interval at 206 and the boundary of the N+1 interval at 208. In this scenario, latency is improved for certain modified asynchronous transfers as well as latency improvement related to modified periodic transfers.

In FIG. 3, period adjustments indicated in the modified periodic transfers 312 may provide a constraint to enforce bandwidth limits for modified asynchronous transfers, such as the modified asynchronous transfer 304, as long as the modified asynchronous transfer 304 is not associated with a bandwidth guarantee. For example, if bandwidth was not available in the interval N, the modified periodic transfer 304 may be delayed to the interval N+1. However, in the case where bandwidth is available as indicated in FIG. 3, the latency may be guaranteed as a measure from the point where the buffer 110 for the modified asynchronous transfer 304 is made available to the host controller 108 and when the host controller 108 begins transactions on the computer bus 112 for that buffer 110.

In some cases, latency round trip latency may be guaranteed. For example, latency between completing an inbound transfer (IN) and a related outbound transfer (OUT) may be bounded to a maximum latency for the roundtrip. Specifically, maximum latency for a roundtrip operation may be equal to the latency for completing an IN for an endpoint A and a maximum latency to scheduling an OUT to an endpoint B.

A final latency may be related to the completion of a bus transaction for an endpoint, such as the endpoint 114 of FIG. 1 to notification provided to software that a given transfer has completed. In some cases, the host controller 108 may have an interrupt moderation policy that is selected by a host controller driver (not shown in FIG. 1) that spans all endpoint data flows. However, the techniques described herein include providing an additional mechanism to select a lower completion indication to software for a specific endpoint data flow.

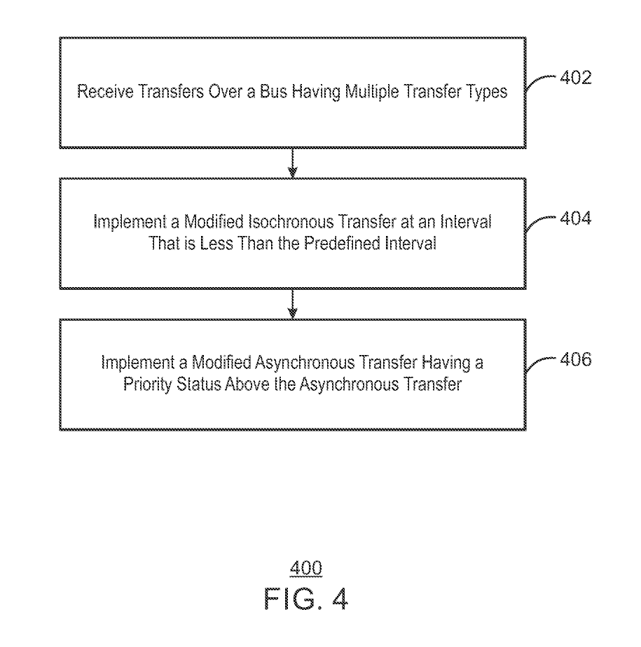

FIG. 4 illustrates a block diagram of a method for improving latency over a computer bus according to techniques described herein. At block 402, the method 400 includes receiving transfers over a bus. The transfers include a periodic transfer at a predefined interval, wherein the periodic transfer is associated with a guaranteed bandwidth over the bus, and an asynchronous transfer at any time within the predefined interval. At block 404, the method 400 includes implementing a modified periodic transfer at an interval that is less than the predefined interval. At block 406, the method 400 includes implementing a modified asynchronous transfer comprising a priority status above the asynchronous transfer.

In some cases, the bus is a Universal Serial Bus (USB) and wherein the predefined interval is a microframe associated with a timing structure of the USB. In this scenario, the transfer interval for the modified periodic transfer is a nanoframe. Further, in some cases, the modified periodic transfer is associated with a guaranteed latency dictated by the interval of the modified periodic transfer. Further, the modified asynchronous transfer may be associated with a bandwidth limit at a priority below the guaranteed bandwidth of the periodic transfer.

The method 400 may further include increasing a priority of the modified asynchronous transfer above the periodic transfer, the modified periodic, or any combination thereof as long as a service interval deadline associated with the periodic transfer, the modified periodic, or any combination is preserved. The method 400 may also further include modifying an interrupt moderation policy of the receiver, the interrupt moderation policy comprising an interrupt interval for notification for completion of a transaction associated with any given transfer.

In some cases, the method 400 may further include determining whether an endpoint of any given transfer is configured to handle the modified asynchronous transfer. In this scenario, the method 400 may also include determining whether an endpoint of any given transfer is configured to handle the modified periodic transfer.

### EXAMPLES

Example 1 is an apparatus for latency improvement, including a receiver configured to receive transfers over a bus, the transfers including: a periodic transfer at a predefined interval. In this example, the periodic transfer is associated with a guaranteed bandwidth over the bus, and an asynchronous transfer at any time within the predefined interval, and logic configured to implement: a modified periodic transfer at an interval that is less than the predefined interval, and a modified asynchronous transfer including a priority status above the asynchronous transfer.

Example 2 includes the apparatus of example 1. In this example, the bus is a Universal Serial Bus (USB) and wherein the predefined interval is a microframe associated with a timing structure of the USB.

Example 3 includes the apparatus of any combination of examples 1-2. In this example, the transfer interval for the modified periodic transfer is a nanoframe.

Example 4 includes the apparatus of any combination of examples 1-3. In this example, the modified periodic transfer is associated with a guaranteed latency dictated by the interval of the modified periodic transfer.

Example 5 includes the apparatus of any combination of examples 1-4. In this example, the modified asynchronous transfer is associated with a bandwidth limit at a priority below the guaranteed bandwidth of the periodic transfer.

Example 6 includes the apparatus of any combination of examples 1-5. In this example logic is configured to increase a priority of the modified asynchronous transfer above the periodic transfer, the modified periodic, or any combination thereof as long as a service interval deadline associated with the periodic transfer, the modified periodic, or any combination is preserved, and as long as associated guarantees in terms of latency are maintained.

Example 7 includes the apparatus of any combination of examples 1-6. In this example, the asynchronous transfer is associated with guaranteed delivery over the bus.

Example 8 includes the apparatus of any combination of examples 1-7. In this example, the logic is configured to modify an interrupt moderation policy of the receiver, the interrupt moderation policy including an interrupt interval for notification for completion of a transaction associated with any given transfer.

Example 9 includes the apparatus of any combination of examples 1-8. In this example, the logic is configured to determine whether an endpoint of any given transfer is configured to handle the modified asynchronous transfer.

Example 10 includes the apparatus of any combination of examples 1-9. In this example, the logic is configured to determine whether an endpoint of any given transfer is configured to handle the modified periodic transfer.

Example 11 is a method of latency improvement, including, receiving transfers over a bus, the transfers including: a periodic transfer at a predefined interval. In this example, the periodic transfer is associated with a guaranteed bandwidth over the bus, and an asynchronous transfer at any time within the predefined interval, and implementing a modified periodic transfer at an interval that is less than the predefined interval, and implementing a modified asynchronous transfer including a priority status above the asynchronous transfer.

Example 12 includes the method of example 11. In this example, the bus is a Universal Serial Bus (USB) and wherein the predefined interval is a microframe associated with a timing structure of the USB.

Example 13 includes the method of any combination of examples 11-12. In this example, the transfer interval for the modified periodic transfer is a nanoframe.

Example 14 includes the method of any combination of examples 11-13. In this example, the modified periodic transfer is associated with a guaranteed latency dictated by the interval of the modified periodic transfer.

Example 15 includes the method of any combination of examples 11-14. In this example, the modified asynchronous transfer is associated with a bandwidth limit at a priority below the guaranteed bandwidth of the periodic transfer.

Example 16 includes the method of any combination of examples 11-15. This example includes increasing a priority of the modified asynchronous transfer above the periodic transfer, the modified periodic, or any combination thereof as long as a service interval deadline associated with the periodic transfer, the modified periodic, or any combination is preserved, and as long as associated guarantees in terms of latency are maintained.

Example 17 includes the method of any combination of examples 11-16. In this example, the asynchronous transfer is associated with guaranteed delivery over the bus.

Example 18 includes the method of any combination of examples 11-17. This example includes modifying an interrupt moderation policy of the receiver, the interrupt moderation policy including an interrupt interval for notification for completion of a transaction associated with any given transfer.

Example 19 includes the method of any combination of examples 11-18. This example includes determining whether an endpoint of any given transfer is configured to handle the modified asynchronous transfer.

Example 20 includes the method of any combination of examples 11-19. This example includes determining whether an endpoint of any given transfer is configured to handle the modified periodic transfer.

Example 21 is a system for latency improvement. In this example, the wireless charging device may include a bus configured to communicate transfers including: a periodic transfer at a predefined interval. In this example, the periodic transfer is associated with a guaranteed bandwidth over the bus, and an asynchronous transfer at any time within the predefined interval, and logic of a receiver communicatively coupled to the bus. In this example, the logic is configured to implement: a modified periodic transfer at an interval that is less than the predefined interval, and a modified asynchronous transfer including a priority status above the asynchronous transfer.

Example 22 includes the system of example 21. In this example, the bus is a Universal Serial Bus (USB) and wherein the predefined interval is a microframe associated with a timing structure of the USB.

Example 23 includes the system of any combination of examples 21-22. In this example, the transfer interval for the modified periodic transfer is a nanoframe.

Example 24 includes the system of any combination of examples 21-23. In this example, the modified periodic transfer is associated with a guaranteed latency dictated by the interval of the modified periodic transfer.

Example 25 includes the system of any combination of examples 21-24. In this example, the modified asynchronous transfer is associated with a bandwidth limit at a priority below the guaranteed bandwidth of the periodic transfer.

Example 26 includes the system of any combination of examples 21-25. In this example logic is configured to increase a priority of the modified asynchronous transfer above the periodic transfer, the modified periodic, or any combination thereof as long as a service interval deadline associated with the periodic transfer, the modified periodic, or any combination is preserved, and as long as associated guarantees in terms of latency are maintained.

Example 27 includes the system of any combination of examples 21-26. In this example, the asynchronous transfer is associated with guaranteed delivery over the bus.

Example 28 includes the system of any combination of examples 21-27. In this example, the logic is configured to modify an interrupt moderation policy of the receiver, the interrupt moderation policy including an interrupt interval for notification for completion of a transaction associated with any given transfer.

Example 29 includes the system of any combination of examples 21-28. In this example, the logic is configured to determine whether an endpoint of any given transfer is configured to handle the modified asynchronous transfer.

Example 30 includes the system of any combination of examples 21-29. In this example, the logic is configured to determine whether an endpoint of any given transfer is configured to handle the modified periodic transfer.

Example 31 is an apparatus for latency improvement, including a receiver configured to receive transfers over a bus, the transfers including: a periodic transfer at a predefined interval. In this example, the periodic transfer is associated with a guaranteed bandwidth over the bus, and an asynchronous transfer at any time within the predefined interval, and a means for implementing: a modified periodic transfer at an interval that is less than the predefined interval, and a modified asynchronous transfer including a priority status above the asynchronous transfer.

Example 32 includes the apparatus of example 31. In this example, the bus is a Universal Serial Bus (USB) and wherein the predefined interval is a microframe associated with a timing structure of the USB.

Example 33 includes the apparatus of any combination of examples 31-32. In this example, the transfer interval for the modified periodic transfer is a nanoframe.

Example 34 includes the apparatus of any combination of examples 31-33. In this example, the modified periodic transfer is associated with a guaranteed latency dictated by the interval of the modified periodic transfer.

Example 35 includes the apparatus of any combination of examples 31-34. In this example, the modified asynchronous transfer is associated with a bandwidth limit at a priority below the guaranteed bandwidth of the periodic transfer.

Example 36 includes the apparatus of any combination of examples 31-35. In this example means for implementing the modified periodic transfer and the modified asynchronous transfer is configured to increase a priority of the modified asynchronous transfer above the periodic transfer, the modified periodic, or any combination thereof as long as a service interval deadline associated with the periodic transfer, the modified periodic, or any combination is preserved, and as long as associated guarantees in terms of latency are maintained.

Example 37 includes the apparatus of any combination of examples 31-36. In this example, the asynchronous transfer is associated with guaranteed delivery over the bus.

Example 38 includes the apparatus of any combination of examples 31-37. In this example, the means for implementing the modified periodic transfer and the modified asynchronous transfer is configured to modify an interrupt moderation policy of the receiver, the interrupt moderation policy including an interrupt interval for notification for completion of a transaction associated with any given transfer.

Example 39 includes the apparatus of any combination of examples 31-38. In this example, the means for implementing the modified periodic transfer and the modified asynchronous transfer is configured to determine whether an endpoint of any given transfer is configured to handle the modified asynchronous transfer.

Example 40 includes the apparatus of any combination of examples 31-39. In this example, the means for implementing the modified periodic transfer and the modified asynchronous transfer is configured to determine whether an endpoint of any given transfer is configured to handle the modified periodic transfer.

Example 41 is a system for latency improvement. In this example, the wireless charging device may include a bus configured to communicate transfers including: a periodic transfer at a predefined interval. In this example, the periodic transfer is associated with a guaranteed bandwidth over the bus, and an asynchronous transfer at any time within the predefined interval, and a means for implementing transfers at a receiver communicatively coupled to the bus, the transfers including: a modified periodic transfer at an interval that is less than the predefined interval, and a modified asynchronous transfer including a priority status above the asynchronous transfer.

Example 42 includes the system of example 41. In this example, the bus is a Universal Serial Bus (USB) and wherein the predefined interval is a microframe associated with a timing structure of the USB.

Example 43 includes the system of any combination of examples 41-42. In this example, the transfer interval for the modified periodic transfer is a nanoframe.

Example 44 includes the system of any combination of examples 41-43. In this example, the modified periodic transfer is associated with a guaranteed latency dictated by the interval of the modified periodic transfer.

Example 45 includes the system of any combination of examples 41-44. In this example, the modified asynchronous transfer is associated with a bandwidth limit at a priority below the guaranteed bandwidth of the periodic transfer.

Example 46 includes the system of any combination of examples 41-45. In this example means for implementing transfers is configured to increase a priority of the modified asynchronous transfer above the periodic transfer, the modified periodic, or any combination thereof as long as a service interval deadline associated with the periodic transfer, the modified periodic, or any combination is preserved, and as long as associated guarantees in terms of latency are maintained.

Example 47 includes the system of any combination of examples 41-46. In this example, the asynchronous transfer is associated with guaranteed delivery over the bus.

Example 48 includes the system of any combination of examples 41-47. In this example, the means for implementing transfers is configured to modify an interrupt moderation policy of the receiver, the interrupt moderation policy including an interrupt interval for notification for completion of a transaction associated with any given transfer.

Example 49 includes the system of any combination of examples 41-48. In this example, the means for implementing transfers is configured to determine whether an endpoint of any given transfer is configured to handle the modified asynchronous transfer.

Example 50 includes the system of any combination of examples 41-49. In this example, the means for implementing transfers is configured to determine whether an endpoint of any given transfer is configured to handle the modified periodic transfer.

An embodiment is an implementation or example. Reference in the specification to ‘an embodiment,’ ‘one embodiment,’ ‘some embodiments,’ ‘various embodiments,’ or ‘other embodiments’ means that a particular feature, structure, or characteristic described in connection with the embodiments is included in at least some embodiments, but not necessarily all embodiments, of the present techniques. The various appearances of ‘an embodiment,’ ‘one embodiment,’ or ‘some embodiments’ are not necessarily all referring to the same embodiments.

Not all components, features, structures, characteristics, etc. described and illustrated herein need be included in a particular embodiment or embodiments. If the specification states a component, feature, structure, or characteristic ‘may’, ‘might’, ‘can’ or ‘could’ be included, for example, that particular component, feature, structure, or characteristic is not required to be included. If the specification or claim refers to ‘a’ or ‘an’ element, that does not mean there is only one of the element. If the specification or claims refer to ‘an additional’ element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus for latency improvement, comprising
a receiver configured to receive transfers over a bus, the transfers comprising:
a periodic transfer at a predefined interval, wherein the periodic transfer is associated with a guaranteed bandwidth over the bus; and
an asynchronous transfer at any time within the predefined interval; and
logic configured to implement:
a modified periodic transfer at an interval that is less than the predefined interval; and
a modified asynchronous transfer comprising a priority status above the asynchronous transfer.

2. The apparatus of claim 1, wherein the bus is a Universal Serial Bus (USB) and wherein the predefined interval is a microframe associated with a timing structure of the USB.

3. The apparatus of claim 2, wherein the transfer interval for the modified periodic transfer is a nanoframe.

4. The apparatus of claim 1, wherein the modified periodic transfer is associated with a guaranteed latency dictated by the interval of the modified periodic transfer.

5. The apparatus of claim 1, wherein the modified asynchronous transfer is associated with a bandwidth limit at a priority below the guaranteed bandwidth of the periodic transfer.

6. The apparatus of claim 1, wherein logic is configured to increase a priority of the modified asynchronous transfer above the periodic transfer, the modified periodic, or any combination thereof as long as a service interval deadline associated with the periodic transfer, the modified periodic, or any combination is preserved, and as long as associated guarantees in terms of latency are maintained.

7. The apparatus of claim 1, wherein the asynchronous transfer is associated with guaranteed delivery over the bus.

8. The apparatus of claim 1, wherein the logic is configured to modify an interrupt moderation policy of the receiver, the interrupt moderation policy comprising an interrupt interval for notification for completion of a transaction associated with any given transfer.

9. The apparatus of claim 1, wherein the logic is configured to determine whether an endpoint of any given transfer is configured to handle the modified asynchronous transfer.

10. The apparatus of claim 1, wherein the logic is configured to determine whether an endpoint of any given transfer is configured to handle the modified periodic transfer.

11. A method of latency improvement, comprising;
receiving transfers over a bus, the transfers comprising:
a periodic transfer at a predefined interval, wherein the periodic transfer is associated with a guaranteed bandwidth over the bus; and
an asynchronous transfer at any time within the predefined interval; and
implementing a modified periodic transfer at an interval that is less than the predefined interval; and
implementing a modified asynchronous transfer comprising a priority status above the asynchronous transfer.

12. The method of claim 11, wherein the bus is a Universal Serial Bus (USB) and wherein the predefined interval is a microframe associated with a timing structure of the USB.

13. The method of claim 12, wherein the transfer interval for the modified periodic transfer is a nanoframe.

14. The method of claim 11, wherein the modified periodic transfer is associated with a guaranteed latency dictated by the interval of the modified periodic transfer.

15. The method of claim 11, wherein the modified asynchronous transfer is associated with a bandwidth limit at a priority below the guaranteed bandwidth of the periodic transfer.

16. The method of claim 11, further comprising increasing a priority of the modified asynchronous transfer above the periodic transfer, the modified periodic, or any combination thereof as long as a service interval deadline associated with the periodic transfer, the modified periodic, or any combination is preserved, and as long as associated guarantees in terms of latency are maintained.

17. The method of claim 11, wherein the asynchronous transfer is associated with guaranteed delivery over the bus.

18. The method of claim 11, further comprising modifying an interrupt moderation policy of the receiver, the interrupt moderation policy comprising an interrupt interval for notification for completion of a transaction associated with any given transfer.

19. The method of claim 11, further comprising determining whether an endpoint of any given transfer is configured to handle the modified asynchronous transfer.

20. The method of claim 11, further comprising determining whether an endpoint of any given transfer is configured to handle the modified periodic transfer.

21. A system for latency improvement, comprising:
a bus configured to communicate transfers comprising:
a periodic transfer at a predefined interval, wherein the periodic transfer is associated with a guaranteed bandwidth over the bus; and
an asynchronous transfer at any time within the predefined interval; and
logic of a receiver communicatively coupled to the bus, wherein the logic is configured to implement:
a modified periodic transfer at an interval that is less than the predefined interval; and
a modified asynchronous transfer comprising a priority status above the asynchronous transfer.

22. The system of claim 21, wherein the bus is a Universal Serial Bus (USB) and wherein the predefined interval is a microframe associated with a timing structure of the USB.

23. The system of claim 21, wherein the modified asynchronous transfer is associated with a bandwidth limit at a priority below the guaranteed bandwidth of the periodic transfer.

24. The system of claim 21, wherein the logic is configured to increase a priority of the modified asynchronous transfer above the periodic transfer, the modified periodic, or any combination thereof as long as a service interval deadline associated with the periodic transfer, the modified periodic, or any combination is preserved.

25. The system of claim 21, wherein the logic is configured to modify an interrupt moderation policy of the receiver, the interrupt moderation policy comprising an interrupt interval for notification for completion of a transaction associated with any given transfer.
